(19) United States
(12) Patent Application Publication
(10) Pub. No.: US 2011/0047101 A1
(43) Pub. Date: Feb. 24, 2011

(54) Internet Digital Mail System Printer

(76) Inventor: Jeffery Scott Caudle, Concord, NC (US)

Correspondence Address: Jeffery Scott Caudle, 7168 Weddington Road NW, Suite 108, Concord, NC, 28027, US

(21) Appl. No.: 12/580,538

(22) Filed: Oct. 16, 2009

Related U.S. Application Data
(60) Provisional application No. 61/234,661, filed on Aug. 18, 2009.

(51) Int. Cl. G06F 17/00

(52) U.S. Cl. 705/407; 700/228

(57) ABSTRACT

This invention relates to a printer that can feed, seal, and print an indicia (Postage Stamp) on a linerless label and/or standard lined label, cut or tear the label (if needed) and apply the printed label to a mailpiece as it is transported all in one pass. Printer will be capable of feeding mailpieces either by hand, semi-automatically or a stack of mailpieces automatically; sealing each mailpiece if needed, and printing an indicia (Postage Stamp) and adhering it to the mailpiece using Internet Based USPS approved software.

### CROSS-REFERENCE TO RELATED APPLICATIONS

This application claims priority from Patent Application No. 61/234,661, filed on Aug. 18, 2009.

### FIELD OF THE INVENTION

The present invention relates exclusively to the domain of a printer that can feed, seal, and print an indicia (Postage Stamp) on a linerless label and/or standard lined label, cut or tear the label (if needed) and apply the printed label to a mailpiece as it is transported all in one pass. Printer will be capable of feeding mailpieces either by hand, semi-automatic, or a stack of mailpieces automatically, sealing each mailpiece if needed, and printing an indicia (Postage Stamp) and adhering it to the mailpiece using Internet Based USPS approved software.

### BACKGROUND OF THE INVENTION

Printers of the thermal type are well known to the person skilled in the art. They allow the printing of postage stamps for mailpieces of different types (envelopes, postcards, etc.). These labels are then hand peeled and stuck on these articles one at a time.

However, up to the present time, no one has considered building a printer that can automatically feed mailpieces/mail transfer cards, print and apply a USPS approved postage label, and seal said mailpieces in one pass using Internet Based USPS approved software.

### SUMMARY OF THE INVENTION

This invention relates to a printer for printing USPS approved indicia labels and applying said printed USPS approved labels directly to mailpieces in one pass automatically, comprising a base module using a thermal printhead, the base comprising first transport means for conveying the mailpieces along a mailpiece conveying path, from a mailpiece inlet towards said printhead module, and label dispensing means towards said mailpiece, characterized in that said dispensing means comprise at least a delivery roll for supplying a band of self-adhesive labels of linerless type or a delivery roll for supplying a band of self-adhesive labels of the lined type.

### BRIEF DESCRIPTION OF THE DRAWINGS

The invention will be more readily understood on reading the following description given by way of indicative and non-limiting example, with reference to the accompanying drawings, in which:

FIG. 1 is a main view of printer from front with the touchscreen display according to the invention.

FIG. 2 is a main view of printer from front without the touchscreen display built in computer according to the invention.

FIG. 3 is a side view of printer showing the sealing slot for the envelope flap according to the invention.

FIG. 4 is a back view of printer according to the invention.

FIG. 5 is a front view of the label pattern of the linerless roll according to the invention.

FIG. 6 is a back view of the belt pattern layout for the linerless roll.

FIG. 7 is a front view of the label pattern of the lined roll according to the invention.

FIG. 8 is a back view of the belt pattern layout for the lined roll.

### DESCRIPTION OF PREFERRED EMBODIMENTS

An Internet Based Digital Mail System Printer is conventionally formed by a base with a thermal printing module connected to this base. The Internet Based Digital Mail System Printer can also be comprised of a built in scale or interfaced external scale via a USB port that can weigh up to 70 lbs. Also, the said printer will be capable of sealing mailpieces automatically as the mailpiece is fed through the printer. The printer can be equipped with a built in touchscreen computer or interfaced with an external computer using USPS approved internet postage software via a USB port. Using the Internet Based Digital Mail System Printer, the operator determines the way each mailpiece/mail transfer card is to be processed (IE First Class, Priority, Express, etc.), places the mailpiece onto the internal/external scale for proper rate calculation, places the mailpieces/mail transfer cards onto the feeder hopper insuring the envelope flaps of the mailpieces that need sealing are placed in the sealer slot of the feed hopper.

The printer is comprised of a feed photo sensor that when covered turns the main drive motor on to begin the process of conveying mailpieces/mail transfer cards through the printer. By placing a stack of mailpieces/mail transfer cards into the feeder hopper, the bottom piece is fed first automatically using a set of automatic adjusting separator fingers to insure each piece is fed one at a time. The mailpiece/mail transfer card will then pass over a second photo sensor that will send a signal to the printhead to print and feed the USPS approved label directly to the mailpiece/mail transfer card. A third photo sensor is used to stop the mailpiece/mail transfer card in the exact holding position by stopping the main drive motor. Once the USPS approved printed label is placed on the mailpiece/mail transfer card, the main drive motor will start again and feed the mailpiece/mail transfer card through a set of rollers to firmly press and adhere the USPS approved label onto the mailpiece/mail transfer card. After exiting the pressure rollers, the envelope will pass through the sealer unit which will wet the envelope flap if needed and then be conveyed through a second set of pressure rollers to apply the right amount of pressure, assuring that the envelope is sealed completely and ejected safely out of the printer.

Referring now to the drawings,

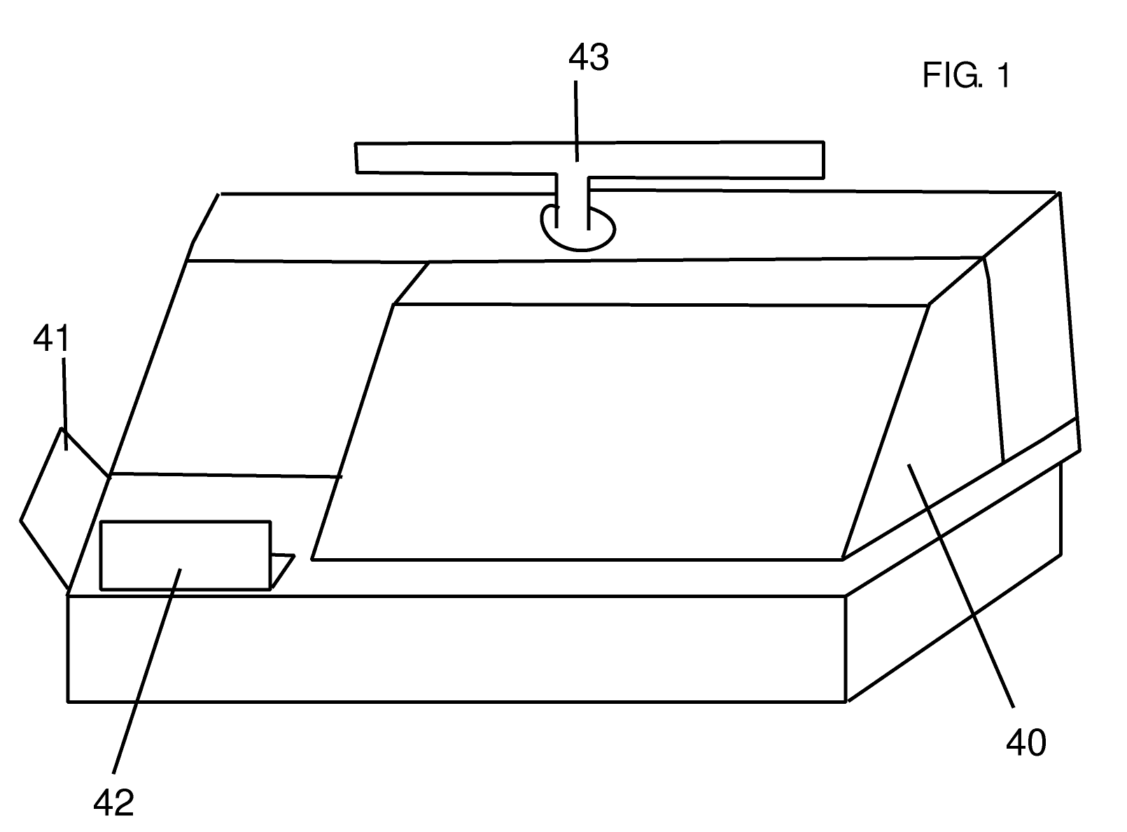

FIG. 1-4 are different views of what the outside of the printer can look like, but not limited to what the actual finished product will be.

FIG. 1 shows the proposed outside view from the front of the printer. The printer will be comprised of a hinged front compartment door 40 which will give access to load the roll of labels. Also, the printer can include an integrated scale 43 which will have a capacity of up to 70 lb.s. The feeder will need a backstop 41 to help angle the stack of mailpieces. A sideguide 42 is used to keep the mailpiece straight as it enters through the separator unit.

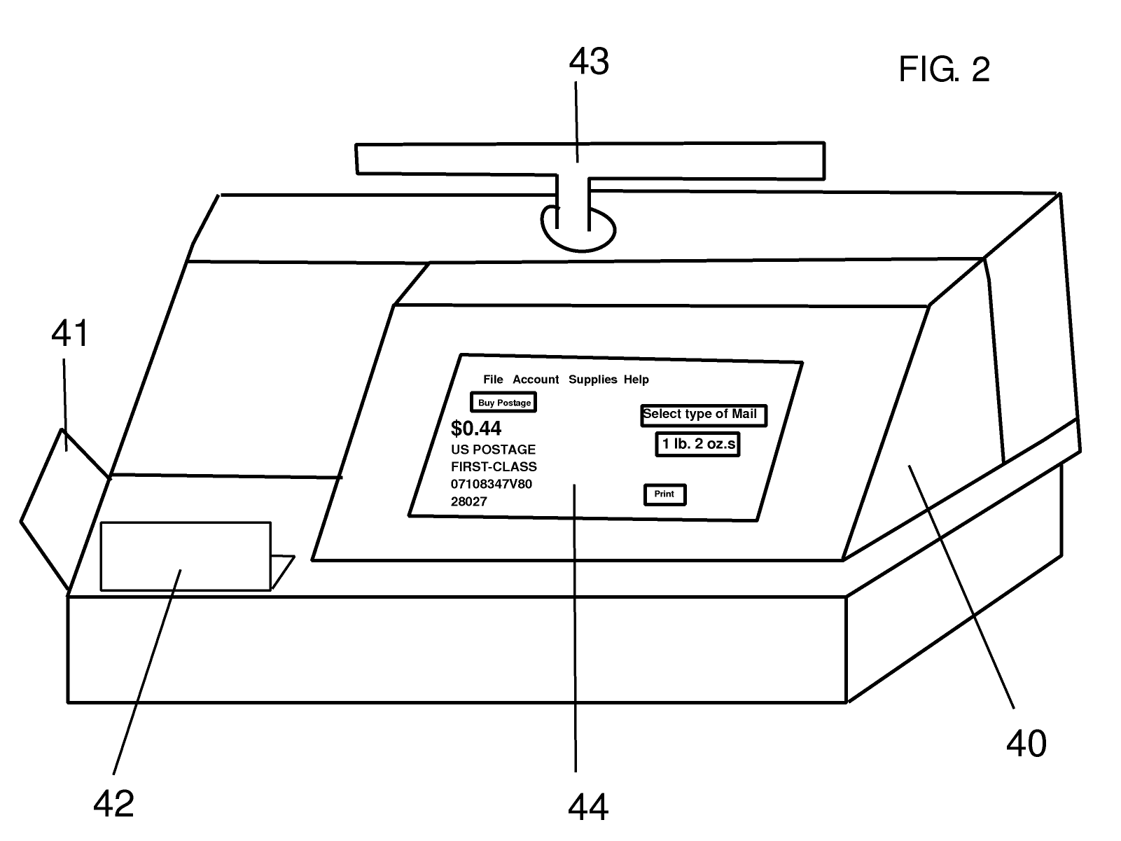

FIG. 2 shows the proposed outside view from the front of the printer. The printer can be comprised of a built in touchscreen 44 computer. Using the touchscreen option, the printer can be used as a stand alone system that will be operational with the use of a network jack to get internet access. A hinged front compartment door 40 will give access to load the roll of USPS approved labels. Also, the printer can include an integrated scale 43 which will have a capacity of up to 70 lb.s. The feeder will need a backstop 41 to help angle the stack of mailpieces. A side guide 42 is used to keep the mailpiece straight as it enters through the separator unit.

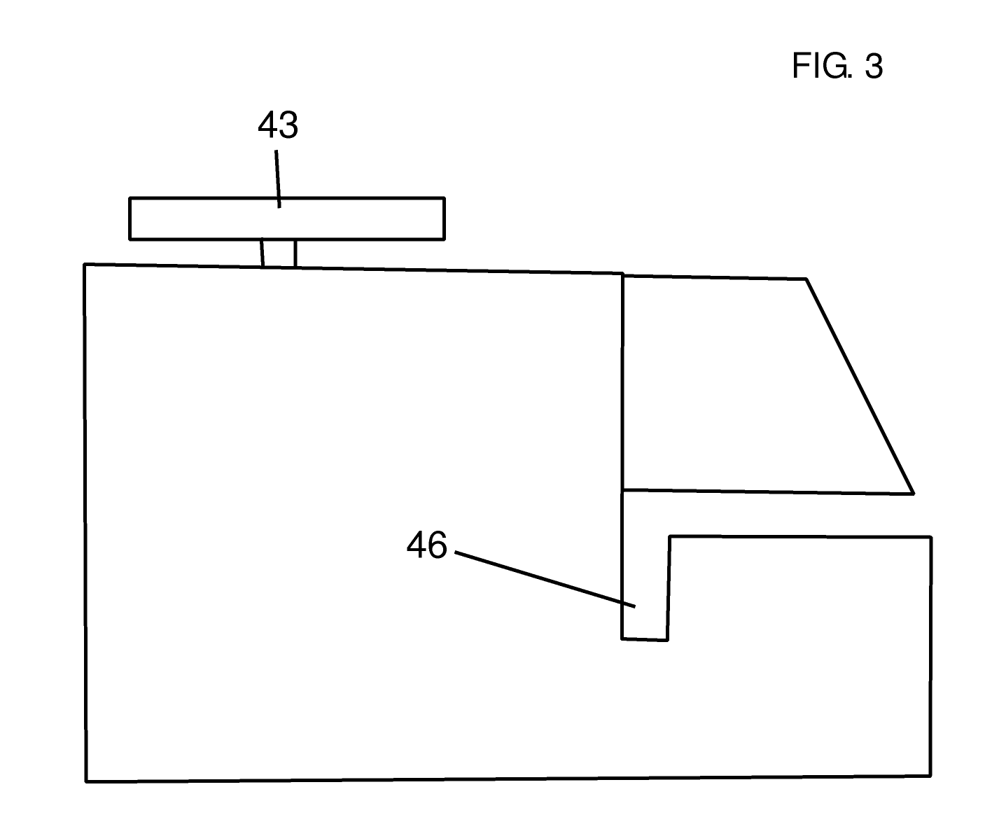

FIG. 3 shows the side view of the printer. This angle shows the slot 46 for the mailpiece flap. When the mailpiece flap is placed into the slot 46, the mailpiece flap will be sealed and closed as it exits the printer.

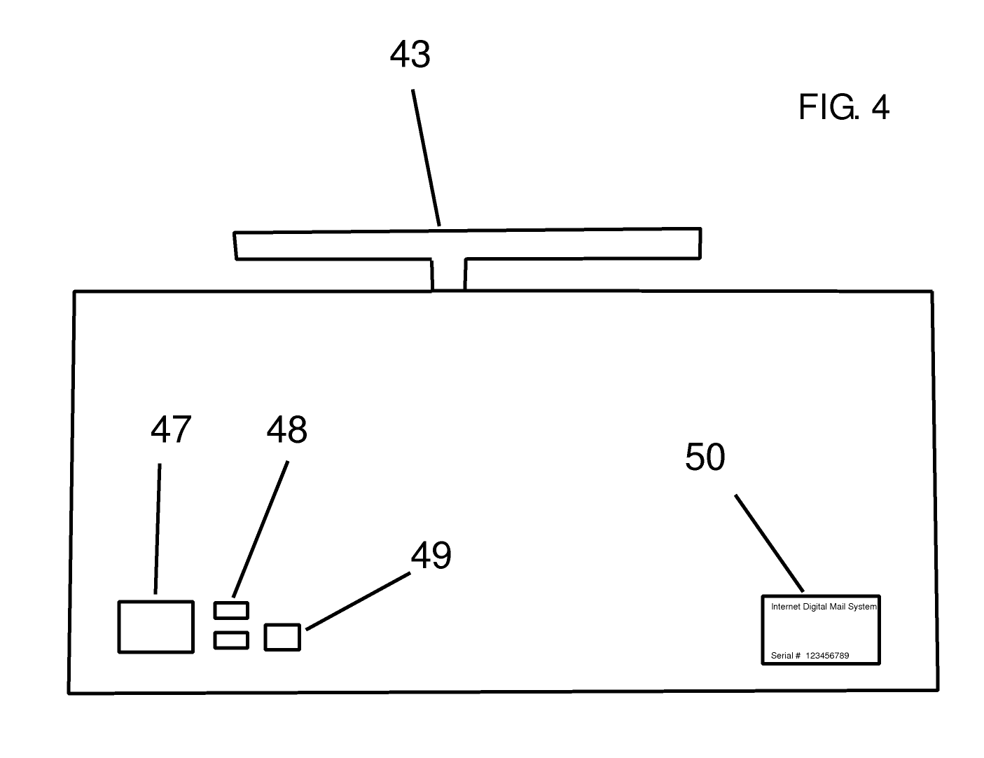

FIG. 4 shows the proposed back view of the printer. The back of the printer can consist of the main power receptacle 47, 2 or more, if applicable, USB ports 48 to interface with a computer, if necessary, and/or an external scale if the internal scale option isn't used. The printer will need to be comprised of a network jack 49 for internet access if the printer isn't interfaced with a computer. Each printer needs to have a serial tag sticker 50 with a unique serial number for tracking each printer.

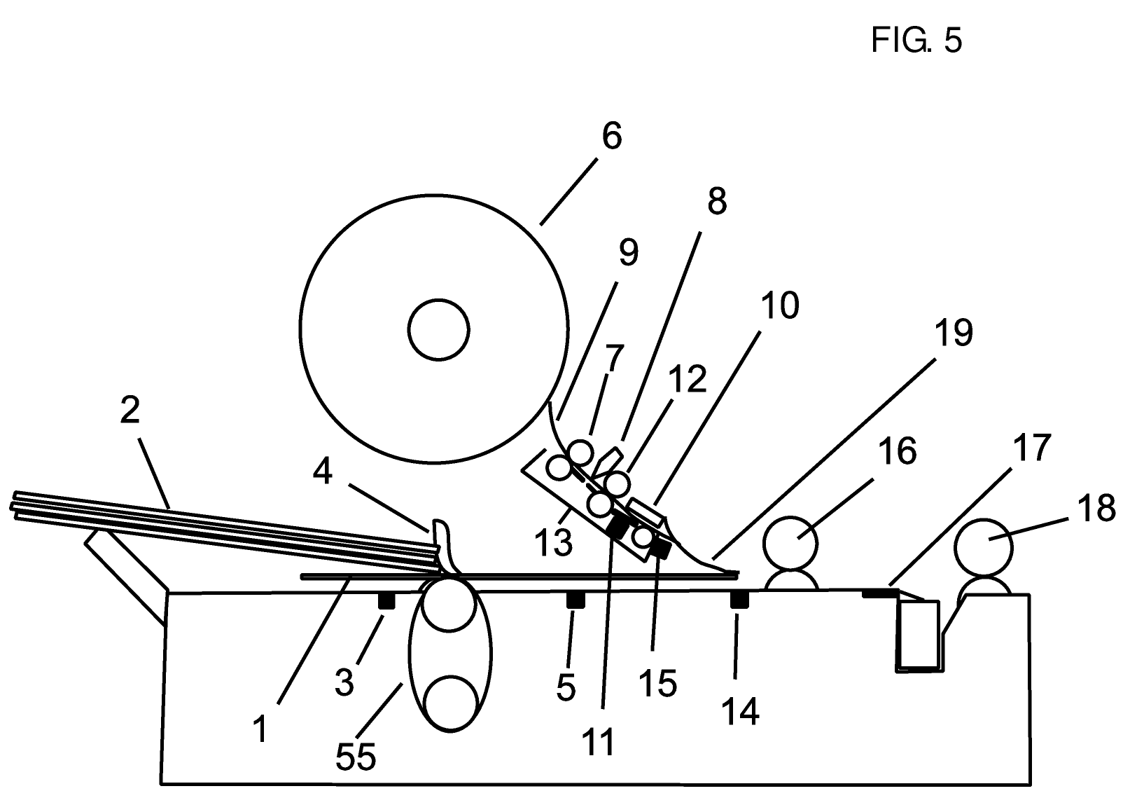

FIG. 5 schematically shows the front view of the linerless roll printer without covers. This shows the path the mailpieces/mail transfer cards 1 as it is fed through the printer. As you can see, the stack 2 of mailpieces is placed onto the feed hopper covering the first photo sensor 3 which in turn starts the main drive motor. As the bottom mailpiece 1 is being fed into the printer by the feed drive belt 55, the separator fingers 4 hold back on the rest of the stack 2 of mailpieces to insure one mailpiece 1 enters the printer at a time. After the mailpiece 1 passes under the separator fingers 4, a second sensor 5 is covered which signals the computer to begin printing the USPS approved label 9. The roll 6 of linerless labels are fed down the path through two sets of non-adherent rollers 7,12. Between these sets of rollers 7,12 is a cutter/perforator bar 8. This cutter/perforator bar 8 can cut/tear the label 9 at the perforation to insure the correct length of the label 9. Once the label 9 has been cut/torn, the label 9 will enter the printhead unit 10 to be printed and then transferred to the mailpiece/mail transfer card 1 using a deflector guide strap 19 to help position the label 9 onto the mailpiece 1. A photo sensor 11 is used at the entrance of the printhead unit 10 to insure the label 9 is in the correct position to be printed. The label path 13 is coated with a non-adherent material, where applicable, to insure the label 9 passes through the path cleanly. The mailpiece then arrives at the third photo sensor 14 which stops the mailpiece 1 to apply the label 9 onto the mailpiece 1. The photo sensor 15 at the exit of the printhead unit 10 signals the base that the label 9 has exited the printhead unit 10 and to turn the main drive motor on. Once the main drive motor is turned back on, the mailpiece 1 is fed through the first set of pressure rollers 16 adhering the label 9 to the mailpiece 1. The mailpiece 1 is then fed through the sealer unit 17 to seal the mailpiece 1 if applicable and then through the second set of pressure rollers 18 to help press and seal the mailpiece 1 as it exits the printer.

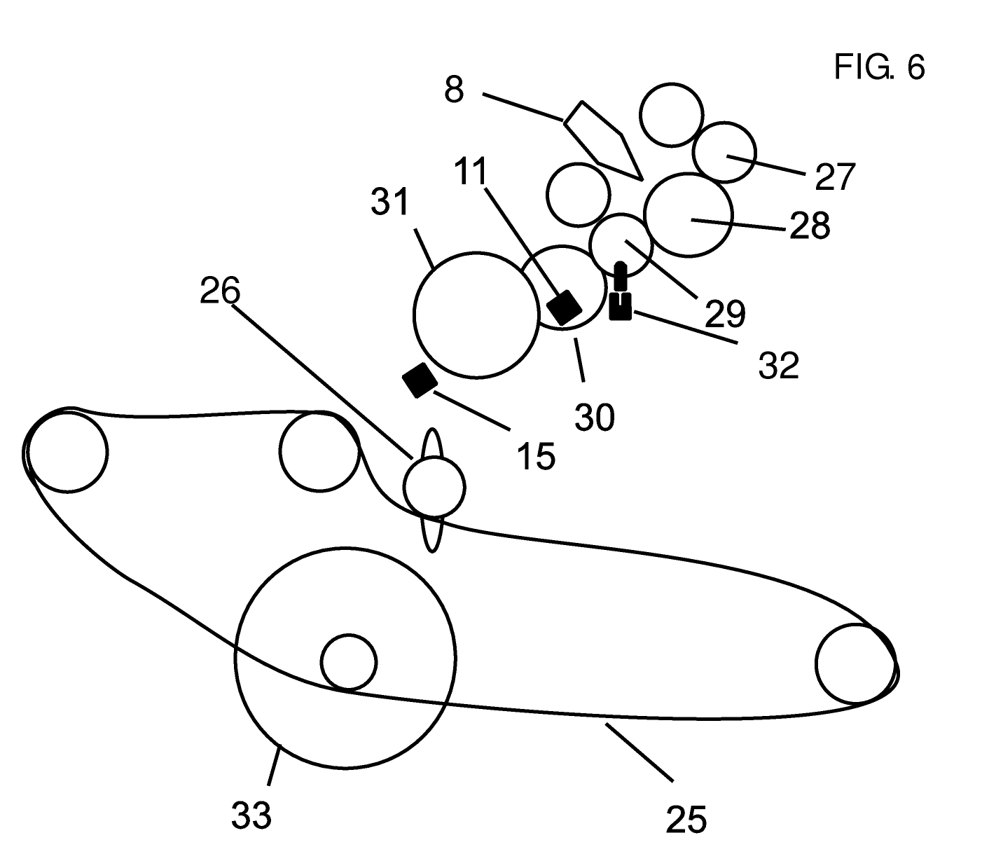

FIG. 6 schematically shows the back view of the printer's belt drive unit of the linerless type. This displays the belt drive direction. The main drive belt 25 turns in a counter clockwise rotation when viewing the printer from the back. The main drive belt 25 uses a slotted/adjustable idler roller 26 to tighten the belt to the right tension. Also shown are the cutter drive gears 27,28,29,30. A cutter drive gear motor 31 rotates the middle drive gear 28 in a clockwise rotation. Once the cutter exit gear 29 rotates one full turn, the cutter activation photo sensor 32 sends a signal to the cutter/perforator bar 8 to activate and cut/tear the label to the right length. The label is then fed into the printhead unit passing over a photo sensor 11 that relays a signal to the printhead to start printing the USPS approved thermal label. After the label exits the printhead unit and the printhead exit photo sensor 15 is unblocked, the main drive motor 33 of the base unit will start to fed the mailpiece/mail transfer card. The label path is coated with a non-adherent material, where applicable, to insure the label passes through the path cleanly.

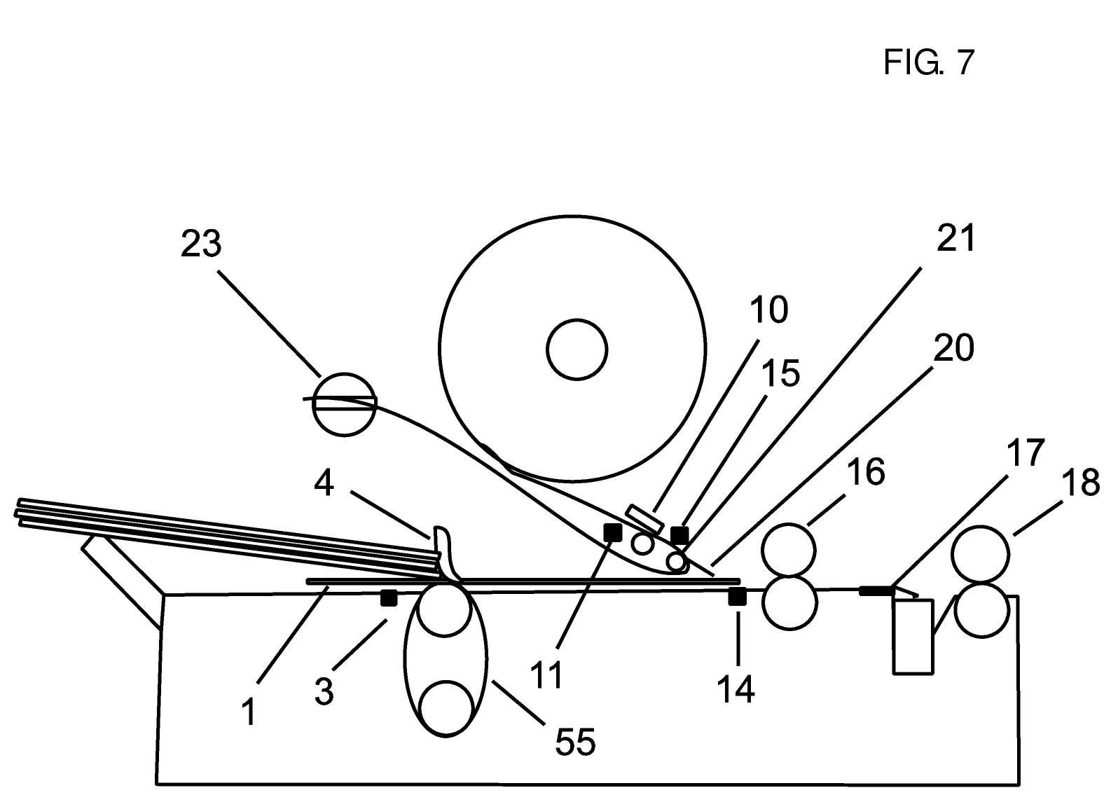

FIG. 7 schematically shows the front the lined roll printer without covers. This shows the path the mailpieces/mail transfer cards 1 as it is fed through the printer. As you can see, the stack 2 of mailpieces is placed onto the feed hopper covering the first photo sensor 3 which in turn starts the main drive motor. As the bottom mailpiece 1 is being fed into the printer by the feed drive belt 55, the separator fingers 4 hold back on the rest of the stack 2 of mailpieces to insure one mailpiece 1 enters the printer at a time. After the mailpiece 1 passes under the separator fingers 4, a second photo sensor 14 is covered which signals the computer to begin printing the USPS approved label 20. The printhead unit 10 is controlled by two photo sensors 11,15 that insure the label 20 is in the correct position to be printed. The printhead motor is reversible to allow the label to be advanced far enough past the peel bar 21 to be placed on the mailpiece/mail transfer card 1. This is accomplished by the two photo sensors 11,15. The photo sensor 15 at the exit of the printhead unit 10 signals the base that the label 20 has exited the printhead unit 10 and to turn the main drive motor on. The excess lined backing/carrier 22 is neatly wound up on the waste collector shaft 23. Once the main drive motor is turned back on, the mailpiece 1 is fed through the first set of pressure rollers 16 adhering the label 20 to the mailpiece 1. The mailpiece 1 is then fed through the sealer unit 17 to seal the mailpiece 1 if applicable and then through the second set of pressure rollers 18 to help press and seal the mailpiece 1 as it exits the printer.

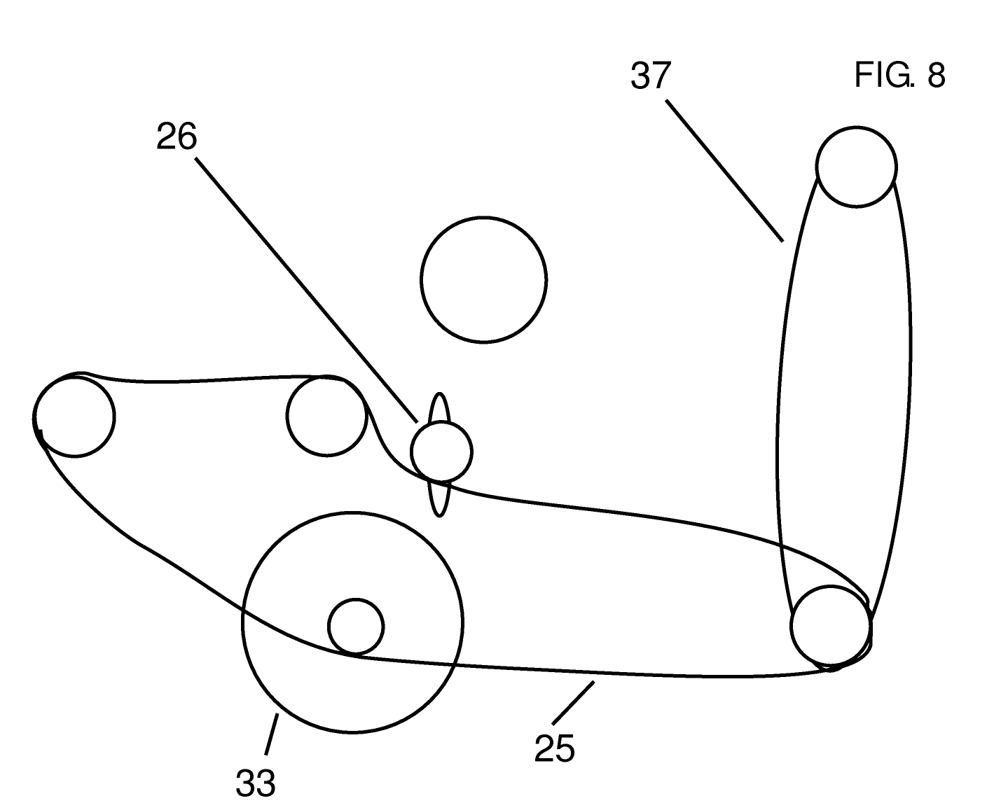

FIG. 8 schematically shows the back view of the printer's belt drive unit of the lined type. This displays the belt drive direction. The main drive belt 25 turns in a counter clockwise rotation when viewing the printer from the back. The main drive belt 25 uses a slotted/adjustable idler roller 26 to tighten the belt to the right tension. Also shown is the waste collector shaft o-ring belt 37. As the printhead prints the USPS approved thermal label, the waste collector o-ring belt 37 turns to wind up the excess backing material on the waste collector shaft. After the label exits the printhead unit and the printhead exit photo sensor is unblocked, the main drive motor 33 of the base unit will start to feed the next mailpiece/mail transfer card.

I claim as my invention:

1. A printer for printing postage stamps from Internet Based USPS approved indicia software either on a linerless label roll or standard lined label roll and applying said label directly to mailpiece or mail transfer card. As mailpiece/mail transfer card is placed in the input area, a photo sensor will be covered and the main motor will begin to feed in said mailpiece/mail transfer card. A second photo sensor will signal the computer to print postage stamp (indicia). When mailpiece/mail transfer card arrives at the adhering stage, a third photo sensor will be covered to stop said mailpiece/mail transfer card. After the postage stamp is applied to the mailpiece/mail transfer card, the main motor will eject the mailpiece/mail transfer card. Once the third photo sensor is uncovered, the main drive motor will begin to feed the next piece and the process starts over again.

2. The printer of claim 1, can either use a built-in touchscreen computer screen or be interfaced with an external computer through a network interface jack.

3. The printer of claim 1, can be comprised of a scale module. The scale module can be comprised of a built-in or external scale that weighs mailpieces up to 70 lbs. By placing a mailpiece on the scale platform, the Internet Based USPS approved software will automatically calculate and display the price of the mailpiece.

4. The printer of claim 1, can be comprised of an envelope sealer module that interfaces with said printer. It will be capable of accepting both sealed and non sealed mailpieces. If the mailpiece needs to be sealed, operator slides mailpiece into sealing slot to seal envelopes as it passes through printer.

5. The printer of claim 1, can also be comprised of an automatic feed module that interfaces with either the sealer module or print module. The automatic feed module will use self-adjusting thickness separator fingers or stationary wheels to insure every mailpiece is fed in one at a time. A photo sensor is used to turn main motor on to start the feeding of mailpieces that are placed in the feed hopper.
